(19) United States
(12) Patent Application Publication
(10) Pub. No.: US 2022/0066718 A1
(43) Pub. Date: Mar. 3, 2022

(54) SERVER, DISPLAY DEVICE, AND METHOD FOR CONTROLLING SAME

(71) Applicant: SAMSUNG ELECTRONICS CO., LTD., Suwon-si, Gyeonggi-do (KR)

(72) Inventors: Hye Ryung KIM, Suwon-si, Gyeonggi-do (KR); Jae JULIEN, Suwon-si, Gyeonggi-do (KR); Yoo Jin CHOI, Suwon-si, Gyeonggi-do (KR); Byeong Ju LEE, Suwon-si, Gyeonggi-do (KR); Jean-Christophe NAOUR, Suwon-si, Gyeonggi-do (KR)

(21) Appl. No.: 17/275,011

(22) PCT Filed: Sep. 9, 2019
(86) PCT No.: PCT/KR2019/011660

§ 371 Date: Mar. 10, 2021

(30) Foreign Application Priority Data
Sep. 10, 2018 (KR) 10-2018-0107964

(51) Int. Cl. G06F 3/14; G06F 3/0484; G06F 3/0482

(52) U.S. Cl. CPC G06F 3/14; G06F 3/0482; G06F 3/04847

(57) ABSTRACT

The present disclosure provides a server through which a user can increase the usability of a content in a display apparatus by providing the content output from the display apparatus based on upload image data, a display apparatus, and a method of controlling the display apparatus. The display apparatus includes a display; a communication interface configured to communicate with the server; and a controller configured to receive a content generated in the server based on image data uploaded by a user to the server, categories selected by the user, and setting information, and to control the content to be output on the display with the setting defined in the setting information.

### TECHNICAL FIELD

The present disclosure is a technology related to a display that can download a content from a server and use the content in a display apparatus.

### BACKGROUND ART

Recently, the display apparatus may provide various functions such as web surfing, VOD viewing, social networking service, and games by combining

Internet access functions and installing various applications.

On the other hand, when users wanted to produce a content of the display apparatus, it was possible to drive on the display apparatus only when a company implemented the content corresponding to a development environment.

Therefore, in order to provide the content in the display apparatus, it is necessary to possess design concept and development technology, and separate time and cost were required.

On the other hand, the users who are not fully equipped with the development technology of a corresponding content have a value of the content with the developed design itself, but there is a problem in that the design cannot be expressed as the content due to lack of technology for developing content to the display apparatus based on the design.

Therefore, there is a demand for various technologies that the users who are not the corresponding companies can easily develop content and provide the content to the display apparatus.

### DISCLOSURE

### Technical Problem

An aspect of the present disclosure is to provide a server through which a user can increase the usability of a content in a display apparatus by providing the content output from the display apparatus based on upload image data, a display apparatus, and a method of controlling the display apparatus.

### Technical Solution

An aspect of the disclosure provides a display apparatus including: a display; a communication interface configured to communicate with the server; and a controller configured to receive a content generated in the server based on image data uploaded by a user to the server, categories selected by the user, and setting information, and to control the content to be output on the display with the setting defined in the setting information.

The content is formed to interact with the image data using a pre-stored resource corresponding to at least one category.

The preset mode may be configured to output a screen including the at least one content to the display while the display apparatus is supplied with a low power.

The image data may include at least one of dynamic and static image data.

The server may be configured to determine whether to provide at least one setting information for changing the content based on at least one category selected by the user.

The server may be configured to determine whether to provide at least one operation element that manipulates an operation of the content based on at least one category selected by the user.

The server may be configured to form a thumbnail for distribution of the content based on the image data, and to upload the content including the thumbnail to at least one app market.

The controller may be configured to download the content based on a user's command and output the content to the display.

The setting information may include at least one of an element in which an interaction between the user and the uploaded image data is possible or an element that changes a form in which the content is displayed on the display.

Another aspect of the disclosure provides a server including: at least one processor; and at least one memory configured to be communicatively connected to the at least one processor, and to store a category and a resource corresponding to the content. The at least one processor may be configured to: communicate with the display; generate the content based on image data uploaded by a user, at least one category selected by the user, and setting information; and transmit the content to the display.

The content is formed to interact with the image data using a pre-stored resource corresponding to at least one category.

The content is formed to output the content with the setting defined in the setting information in a preset mode of the display.

The image data may include at least one of dynamic and static image data.

The at least one processor may be configured to determine whether to provide at least one setting information for changing the content based on at least one category selected by the user.

The at least one processor may be configured to determine whether to provide at least one operation element that manipulates an operation of the content based on at least one category selected by the user.

The at least one processor may be configured to form a thumbnail for distribution of the content based on the image data, and to upload the content including the thumbnail to at least one app market.

Another aspect of the disclosure provides a method of controlling a display apparatus including: communicating with a server by a communication interface;

receiving, by a controller, a content generated in the server based on image data uploaded by a user to the server, categories selected by the user, and setting information; and controlling, by the controller, the content to be output on the display with the setting defined in the setting information.

The content is formed to interact with the image data using a pre-stored resource corresponding to at least one category.

The controlling of the content to be output on the display may include outputting a screen including the at least one content to the display while the display apparatus is supplied with a low power.

The image data may include at least one of dynamic and static image data.

The controlling of the content to be output on the display may include downloading the content based on a user's command and outputting the content to the display.

The setting information may include at least one of an element in which an interaction between the user and the uploaded image data is possible or an element that changes a form in which the content is displayed on the display.

### Advantageous Effects

According to a server, a display apparatus, and a method of controlling the display apparatus of an embodiment, a user may provide a content from a display apparatus based on upload image data, thereby increasing the usability of a corresponding content in the display apparatus.

### DESCRIPTION OF DRAWINGS

FIG. 1 is a view illustrating a display apparatus according to an embodiment.

FIG. 2 is a control block diagram of a display system according to an embodiment.

FIG. 3 is a control block diagram of a display apparatus according to an embodiment.

FIG. 4 is a view for describing an operation of deriving a content from image data through a resource according to an embodiment.

FIG. 5 is a view for describing a predetermined driving mode according to an embodiment.

FIG. 6 is a view for describing an operation of uploading image data to be used for a content according to an embodiment.

FIG. 7 is a view for describing an operation of a user selecting a category according to an embodiment.

FIG. 8 is a view for describing an operation of forming a content according to an embodiment.

FIG. 9 is a view for describing an operation of providing setting information and operation element according to an embodiment.

FIGS. 10 and 11 are views for describing an example of operation element and setting information different from those of FIG. 9.

FIG. 12 is a view illustrating an operation of forming a thumbnail and uploading a corresponding content to a market according to an embodiment.

FIG. 13 is a view for describing a preview operation according to an embodiment.

FIGS. 14 to 15 are flowcharts according to an embodiment.

### MODES OF THE INVENTION

Like reference numerals refer to like elements throughout the specification. Not all elements of the embodiments of the disclosure will be described, and the description of what are commonly known in the art or what overlap each other in the exemplary embodiments will be omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be further understood that the term “connect” and its derivatives refer both to direct and indirect connection, and the indirect connection includes a connection over a wireless communication network.

The terms “include (or including)” and “comprise (or comprising)” are inclusive or open-ended and do not exclude additional, unrecited elements or method steps, unless otherwise mentioned. It will be further understood that the term “member” and its derivatives refer both to when a member is in contact with another member and when another member exists between the two members.

Further, when it is stated that a layer is “on” another layer or substrate, the layer may be directly on another layer or substrate or a third layer may be disposed therebetween.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Hereinafter, an operation principle and embodiments of the disclosure will be described with reference to accompanying drawings.

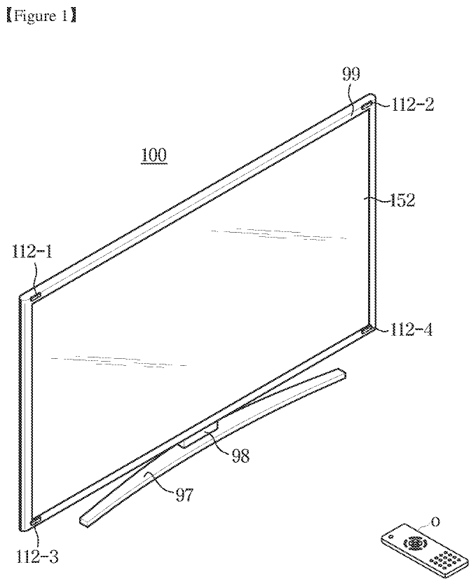

FIG. 1 is a view illustrating a display apparatus according to an embodiment.

Referring to FIG. 1, a display apparatus 100 according to an embodiment may include an exterior housing 99, a display panel 152, a support 98, and a leg 97.

The exterior housing 99 defines an exterior appearance of the display apparatus 100 and includes components of the display apparatus 100 used to display various images or perform various functions. The exterior housing 99 may be formed as a single piece or as a combination of a plurality of housings, e.g., a combination of a front housing and a rear housing. An intermediate housing may further be provided inside the exterior housing 99.

The display panel 152 may be provided on the front surface of the exterior housing 99 and display various images. Particularly, the display panel 152 may display at least one or more still images or moving images. The display panel 152 may also be implemented using separate components such as a touch panel, depending on an embodiment.

The support 98 serves to connect the exterior housing 99 with the leg 97 while supporting the exterior housing 99. The support 98 may have various shapes according to designer's selection or may be omitted, depending on an embodiment. The support 98 may be attached to or detached from the exterior housing 99, depending on an embodiment. In addition, the display apparatus 100 may include at least one antenna 112-1 to 112-4.

The leg 97 may be connected to the support 98 such that the exterior housing 99 is stably mounted on the floor. The leg 97 may be coupled to or separated from the support 98, depending on an embodiment. The leg 97 may be directly connected to the exterior housing 99. According to another exemplary embodiment, the leg 97 may be omitted.

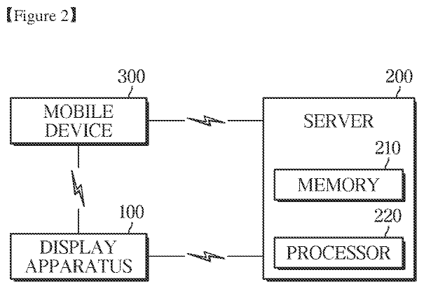

FIG. 2 is a control block diagram of a display system according to an embodiment.

A display system 1 may include a mobile device 300, a server 200, and the display apparatus 100.

The mobile device 300 may be implemented as a device capable of receiving a user's command

The user may upload image data to the server 200 through the mobile device 300.

The user may select a category corresponding to the image data uploaded through the mobile device 300. Examples of categories may be provided in advance to the server 200.

Meanwhile, the user may download the content formed based on the image data uploaded by the user through the mobile device 300.

The user may input a preview command through the mobile device 300 and output the preview command to the display apparatus 100.

The user may upload the image data to the server 200 through the mobile device 300, and the user may download the content formed based on an operation to be described later from the server 200. In addition, the user may implement the operations described throughout the disclosure through a mobile. In addition, the image data and the content uploaded by the user may be downloaded through the mobile.

The mobile device 300 may be implemented as a computer or a portable terminal capable of connecting to the server 200 and the display apparatus 100 through a network. Here, the computer may include, for example, a notebook, a desktop, a laptop, a tablet PC, a slate PC, and the like, each of which is equipped with a WEB Browser. The user terminal 200 may include, for example, a wearable device such as a Personal Communication System (PCS), or the like as a wireless communication device that is guaranteed to be portable and mobile. The portable terminal may be any type of handheld-based wireless communication device such as a Personal Communication System (PCS), Global System for Mobile communications (GSM), Personal Digital Cellular (PDC), Personal Handyphone System (PHS), Personal Digital Assistant (PDA), International Mobile Telecommunications (IMT)-2000, Code Division Multiple Access (CDMA)-2000, W-Code Division Multiple Access (W-CDMA), Wireless Broadband (WiBro) Internet terminal, a smart phone, etc., a wearable device such as a watch, a ring, a bracelet, an anklet, a necklace, a pair of glasses, and contact lens, or a head-mounted-device (HMD).

The server 200 may provide the category corresponding to the image data to the user. The user may generate the content based on the category provided by the server 200.

A pre-stored resource may be used for the server 200 to form the content based on the image data uploaded by the user.

In addition, the server 200 may provide setting information and operation element for changing the content based on at least one category selected by the user.

The setting information may include an element that changes an appearance of the content. For example, the setting information may include those related to a color and shape of the corresponding content.

The operation element may include an element that can control the function of the content. For example, the operation element may include a configuration for controlling a volume when the content is a radio.

According to another embodiment, when the content is a clock, the operation element may include an element for changing an alarm of the clock.

In addition, the server 200 may form a thumbnail based on the image data uploaded by the user.

The server 200 may include at least one processor 220 and at least one memory 210.

The at least one processor 220 may communicate with at least one of the mobile device 300 and the display apparatus 100, generate the content based on the image data uploaded by the user through the mobile device 300 and at least one category selected by the user, and transmit the content to the display apparatus 100. At least one processor 220 may include a communication module.

The content may include an application type implemented in the display apparatus 100 based on the image data uploaded by the user.

Meanwhile, the content may be formed to be output in at least one predetermined driving mode provided by the display apparatus 100. The predetermined driving mode may include a power saving mode, which will be described later in detail.

In addition, at least one processor 220 may provide the setting information and the operation element for changing the content to the user. The setting information and operation element may include elements that can be set for the corresponding content and elements related to the operation of the content.

Meanwhile, the at least one processor 220 may form the thumbnail based on the image data uploaded by the user.

The thumbnail may be provided in a reduced form of the image data.

Thumbnails make it easier to recognize while browsing photos, and can treat pictures the same as normal string indexes. The thumbnail provided by the server 200 based on the image data uploaded by the user may be provided to the market when the user downloads the content, as described later.

The server 200 may include at least one memory 210.

The memory 210 may store resources used to form the content based on the category selectable by the user and the image data uploaded by the user.

The memory 210 may be implemented using at least one of a non-volatile memory element, e.g., a cache, a Read Only Memory (ROM), a Programmable ROM (PROM), an Erasable Programmable ROM (EPROM), an Electrically Erasable Programmable ROM (EEPROM) and a flash memory; a volatile memory element, e.g., a Random Access Memory (RAM); or a storage medium, e.g., a Hard Disk Drive (HDD) and a CD-ROM. The implementation of the storage is not limited thereto. The memory 210 may be a memory that is implemented by a separate memory chip from the aforementioned processor related to the processor 220 or the memory 210 may be implemented by a single chip with the processor 220.

The display apparatus 100 may communicate with the mobile device 300 and the server 200 to output the downloaded content. A detailed description of the display apparatus 200 will be described below.

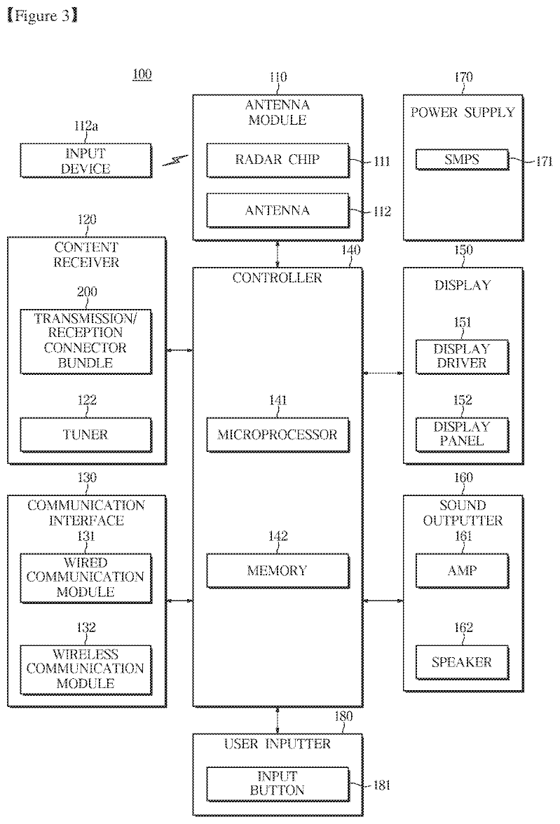

FIG. 3 is a control block diagram of a display apparatus according to an embodiment.

Referring to FIG. 3, the display apparatus 100 includes an antenna module 110 to receive a signal from an input device 112a, a user inputter 180 to receive a user's input from a user, a communication interface 130 to communicate with an external device 130, a controller 140 to control the operation of the display apparatus 100 and process video signals and/or audio signals received from a content receiver 120 and/or the communication interface 130, a display 150 to display an image processed by the controller 140, a sound outputter 160 to output sound processed by the controller 140, and a power supply 170 to supply power to the components of the display apparatus 100.

The antenna module 110 is a configuration capable of transmitting and receiving signals to and from the input device 112a, and may include three or more antennas 112 and a radar chip 111 to transmit and receive a signal composed of specific pulse components in a predetermined frequency band using the antenna 112.

The antenna 112 may be connected to the input device 0 capable of transmitting or receiving a signal composed of specific pulse components in a predetermined frequency band and the controller 140 capable of performing a distance measurement and coordinate extraction using signals received from the radar chip 111.

The antenna module 110 may include the antenna 112 for receiving a remote control signal of the input device 112a. The input device 112a for receiving the user input may be provided separately from the display apparatus 100, and may receive a user input and transmit a wireless signal corresponding to the user input to the display apparatus 100. The antenna module 110 may receive the wireless signal corresponding to the user input from the input device 112a, and output an electrical signal corresponding to the user input to the controller 140.

The display apparatuses 100 may share one input device 112a, and a user input inputted to the input device 112a may be transmitted to all of the display apparatuses 100. The display apparatus 100 may receive a user input regarding a change of an image source device 20 or 30 through the antenna 112.

The controller 140 may receive the content linked to the image data from the server 200 based on the image data uploaded by the user, the at least one category selected by the user, and the setting information. In the preset mode, the controller 140 may output the content on the display 150 with the settings defined in the setting information.

In addition, the controller 140 may output the content on the display 150 based on the preview command input by the user through the mobile device 200.

The content output on the display 150 may be formed using pre-stored resources corresponding to at least one category and the image data. Further, the content may be output in at least one predetermined driving mode provided by the display apparatus 100. The predetermined driving mode will be described later.

Meanwhile, the image data uploaded by the user may include at least one of dynamic and static image data.

The controller 140 may control to download the content based on the user's command and control to output the content to the sound outputter 160, and may output the content to the sound outputter 160 based on the preview command through the mobile.

The controller 140 may process image frame data and/or video/audio signals received by the content receiver 120 and/or the communication interface 130. For example, the controller 140 may output image frame data received from the content receiver 120 to the display 150. In addition, the controller 140 may process the video/audio signals received by the content receiver 120 and/or the communication interface 130, and output image frame data generated from the video/audio signals to the display 150.

The controller 140 may control the operations of the content receiver 120, the display 150, and the sound outputter 160 according to the operation state of the display apparatus 100 and/or a user input. For example, when a content source is selected by a user input, the controller 140 may control the content receiver 120 to receive image frame data from the selected content source. In addition, when the image frame data is not received through the content receiver 120, the controller 140 may control the content receiver 120 to receive image frame data from another content source.

In particular, the controller 140 may output a selection signal for selecting a source from which to receive image frame data to a transmission/reception connector bundle 200 of the content receiver 120. The controller 140 may include a microprocessor 141 and a memory 142.

The memory 142 may store programs and data for processing image frame data and/or video/audio signals, and may temporarily memorize data generated during processing of the image frame data and/or video/audio signals. In addition, the memory 142 may store programs and data for controlling the components included in the display apparatus 100 and temporarily memorize data generated during the control of the components included in the display apparatus 100.

The memory 142 may include a non-volatile memory for storing data for a long time, such as a read only memory (ROM) and a flash memory, and a volatile memory for temporarily memorizing data, such as a static random access memory (S-RAM), Dynamic Random Access Memory (D-RAM).

The microprocessor 141 may receive image frame data and/or video/audio signals from the content receiver 120 and/or the communication interface 130. The microprocessor 141 may output the image frame data received from the content receiver 120 to the display 150 and the sound outputter 160. In addition, the microprocessor 141 may decode the video signal to generate image frame data, decode the audio signal to generate sound data, and output the image frame data and sound data to the display 150 and the sound outputter 160, respectively.

The microprocessor 141 may receive the user input from the user inputter 180, and control a control signal for controlling the content receiver 120 and/or the display 150 and/or the sound outputter 160 according to the user input. In addition, the microprocessor 141 may generate a control signal for controlling the operation of the content receiver 120 according to whether image frame data is received through the content receiver 120.

The microprocessor 141 may include an arithmetic circuit that performs logical operations and arithmetic operations, and a memory circuit that memorizes calculated data.

The controller 140 may convert sound data decoded from the audio signal into an analog acoustic signal, and an amplifier 161 may amplify the analog sound signal output from the controller 140.

The user inputter 180 may include an input button group 181 that receives a user input.

For example, the user inputter 180 may include a power button for turning on or off the display apparatus 100, a channel selection button for selecting broadcast content displayed on the display apparatus 100, a sound control button for adjusting the volume of the sound output from the display apparatus 100, a source selection button for selecting a content source, and the like.

The input button group 181 may receive respective user inputs and output electrical signals corresponding to the user inputs to the controller 140. The input button group may be implemented using various input devices, such as a push switch, a touch switch, a dial, a slide switch, a toggle switch, and the like.

The tuner 122 may receive a broadcast signal from a broadcast reception antenna or a wired cable, and extract a broadcast signal of a channel selected by a user from among the broadcast signals. For example, the tuner 122 may pass a broadcast signal having a frequency corresponding to a channel selected by a user among a plurality of broadcast signals received through the broadcast reception antenna or the wired cable, and block a broadcast signal having a different frequency.

As such, the content receiver 120 may receive image frame data and/or video/audio signals through the transmission/reception connector bundle 200 and/or the tuner 122, and output the image frame data and/or video/audio signals received through the transmission/reception connector bundle 200 and/or the tuner 122 to the controller 140.

The communication interface 130 may include a wired communication module 131 and a wireless communication module 132 that may exchange data with external devices. In particular, the communication interface 130 may communicate with the server 200 or the mobile device 300.

The wired communication module 131 may be connected to a communication network through a cable and exchange data with an external device through the communication network. For example, the wired communication module 131 is connected to a communication network through Ethernet (Ethernet, IEEE 802.3 technology standard), and exchanges data with first and second image source devices 120 and 130 and/or external devices through the communication network.

The wireless communication module 132 may wirelessly communicate with an access point (AP), and connect to a communication network through the AP and exchange data with the first and second image source devices 120 and 130 and/or the external devices through the communication network. For example, the wireless communication module 132 may communicate with the AP through Wi-Fi (WiFi™, IEEE 802.11 technology standard), Bluetooth (Bluetooth™, IEEE 802.15.1 technology standard), ZigBee™ (IEEE 802.15.4 technology standard). The wireless communication module 132 may exchange data with an external device through the AP.

The communication interface 130 may receive image frame data through the communication network.

The display 150 may include a display panel 152 for visually displaying an image, and a display driver 151 for driving the display panel 152.

The display panel 152 may generate an image according to image data received from the display driver 151 and display the image.

The display panel 152 may include a pixel that serves as a unit for displaying an image. Each pixel may receive an electrical signal representing an image from the display driver 151, and output an optical signal corresponding to the received electrical signal. As such, optical signals output from a plurality of the pixels are combined so that one image may be displayed on the display panel 152.

The display driver 151 may receive image data from the controller 140 and drive the display panel 152 to display an image corresponding to the received image data. Particularly, the display driver 151 may transmit an electrical signal corresponding to image data to each of a plurality of pixels constituting the display panel 152.

When the display driver 151 transmits an electrical signal corresponding to image data to each pixel constituting the display panel 152, each pixel outputs light corresponding to the received electrical signal, and light output from each pixel is combined to form an image.

The sound outputter 160 may include the amplifier 161 for amplifying sound, and a speaker 162 for acoustically outputting the amplified sound.

The speaker 162 may convert the analog acoustic signal amplified by the amplifier 181 into sound (a sound wave). For example, the speaker 182 may include a thin film that vibrates according to an electrical acoustic signal, and sound waves may be generated by the vibration of the thin film.

The power supply 170 may supply power to the user inputter 180, the content receiver 120, the communication interface 130, the controller 140, the display 150, the sound outputter 160, and all other components.

The power supply 170 includes a switching mode power supply 171 (hereinafter, referred to as ‘SMPS’).

The SMPS 171 may include an AC-DC converter that converts AC power of an external power source into DC power, and a DC-DC converter that changes the voltage of the DC power. For example, AC power of an external power source is converted to DC power by the AC-DC converter, and the voltage of the DC power may be changed to various voltages (for example, 5V and/or 15V) by the DC-DC converter. The DC power with varying voltages may be supplied to the user inputter 180, the content receiver 120, the controller 140, the display 150, the sound outputter 160, and all other components.

In addition, the transmission/reception connector bundle 200 may include a switch part for selecting source of image frame data.

At least one component may be added or omitted to correspond to the performances of the components of the display apparatus shown in FIG. 3. In addition, it would be understood by those skilled in the art that the mutual positions of the components may be changed to correspond to the performance or structure of the system.

Meanwhile, the components illustrated in FIG. 3 may refer to a software component and/or a hardware component, such as a Field Programmable Gate Array (FPGA) and an Application Specific Integrated Circuit (ASIC).

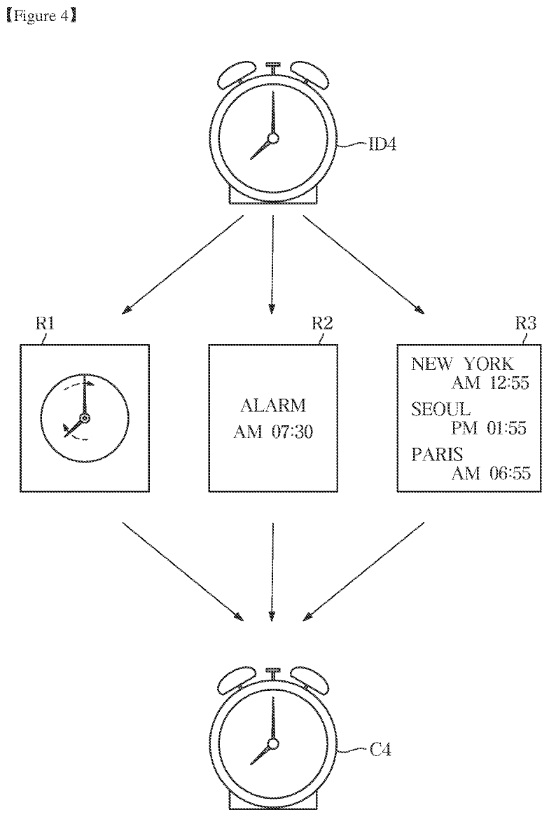

FIG. 4 is a view for describing an operation of deriving a content from image data through a resource according to an embodiment.

Referring to FIG. 4, an operation of forming a content C4 using at least one resource R1, R2, and R3 using image data ID4 uploaded by the user will be described.

The user may upload the at least one image data ID4 using a provided tool. A detailed operation of uploading the image data ID4 will be described later.

In addition, the user may select a category of content to be generated based on a nature of the image data ID4, as described later. In FIG. 4, the user uploads image data of “clock”, and the user may select “clock” from the categories.

Meanwhile, according to an embodiment, the server 200 may generate the content by providing the at least one resource R1, R2, and R3 based on the image data ID4 uploaded by the user and the category selected by the user.

In FIG. 4, three resources corresponding to “clock” are exemplarily presented.

The server 200 may provide the resource R1 for implementing a clock operation from the image data uploaded by the user. For example, the server 200 may derive a feature point of a clock hand from the image data uploaded by the user based on the corresponding resource R1 and generate the content C4 corresponding to output to the display apparatus 100. The user may be provided with content including the form of an image output to the display apparatus 100 based on the resource R1 and image data provided from the server 200 without the need to produce separate content corresponding to the display apparatus.

In addition, when the user selects the “Clock” category, the server 200 may also provide the resource R2 related to an alarm. The content C4 driven by the display apparatus 100 may include functional operations in addition to visual operations. Even if only the image data ID4 corresponding to the clock is uploaded, the user may apply the resource R2 related to the alarm function provided from the server 200 to the corresponding image data to form the content. Meanwhile, the alarm-related resource described in FIG. 4 may be related to operation element to be described later. A detailed description of this will be described later.

In addition, as the user selects the “Clock” category, the server 200 may also provide the resource R3 related to world time. The content C4 driven by the display apparatus 100 may include functional operations in addition to visual operations. Even if the user uploads only the image data corresponding to the clock, the server 200 may apply the resource R3 related to a time of another place to the corresponding image data to form the content.

In summary, the server 200 may provide the at least one resource R1, R2, and R3 based on the image data ID4 uploaded by the user and the category “Clock” selected by the user to form the content C4 that can be used in the display apparatus 100 and provide the content C4 to the user.

Meanwhile, the operation described in FIG. 4 is only an exemplary embodiment for describing an operation in which the content is derived from the image data, and there is no limitation on the types of the image data and the categories.

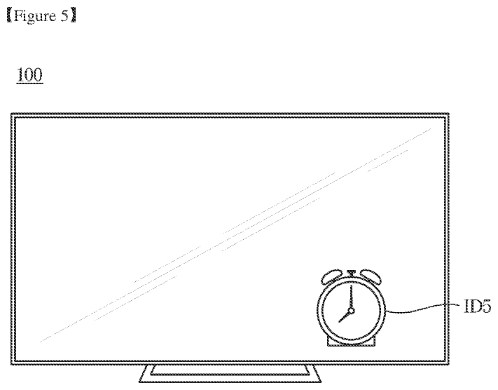

FIG. 5 is a view for describing a predetermined driving mode according to an embodiment.

A content C5 derived by the above-described method may be output from the display apparatus 100 and be used, but in particular, the content C5 may be used only in a preset mode of the display apparatus 100.

The preset mode may include a driving mode that identifies information such as weather, time, news, or outputs the photo or the image to the display 150 when an off command is input to the display apparatus 100.

The preset mode may be implemented so that even when the user does not view the display apparatus 100, a surrounding pattern of the display apparatus 100 is recognized so that a screen of the display apparatus 100 can be arranged without feeling of disparity with a surrounding space. The preset mode may display a screen including an image on a standby screen. For convenience of explanation, the preset mode may be referred to as an ambient mode, a standby screen mode, a standby mode, and a power saving mode.

Also, the preset mode may include the power saving mode.

The power saving mode is one of the system standby power management programs. In the power saving mode, other components may not be powered, except for the essential components to drive a system. Meanwhile, an element essential for driving the system may include at least one of the components illustrated in FIG. 3.

In addition, the content formed through FIG. 4 may be output in the preset mode described in FIG. 5.

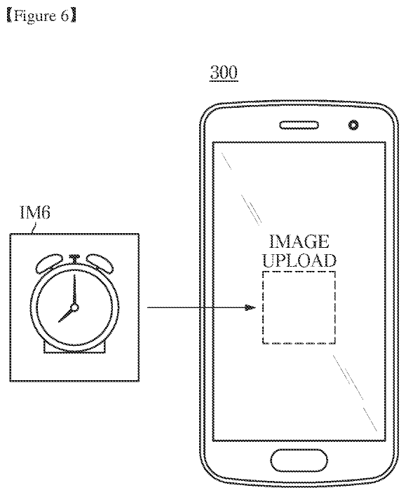

FIG. 6 is a view for describing an operation of uploading image data to be used for a content according to an embodiment.

Referring to FIG. 6, the user may upload image data IM6 related to an appearance of a product developed by the user using a tool provided by the server 200. The image data uploaded by the user may include static image data and dynamic image data. The image data may include image data based on raster graphics, image data based on a vector format, image data based on a complex format, and image data based on a stereo format. Particularly, the image data may include image data in the form of JPEG, EXIF, TIFF, GIF, BMP, and PNG, but there is no limitation on the form of image data.

On the other hand, when the user uploads the image data and selects the category, the server 200 may derive the content by using the resource corresponding to the image data. However, when the content cannot be formed because the server 200 cannot determine the resource corresponding to the image data, the user may upload the image data by changing the format.

In other words, when the resource provided by the server 200 fails to derive the appropriate feature points of the image data uploaded by the user, the user may change the form of the image data and reload the image data M6 so that the resource can derive the feature points from the image data.

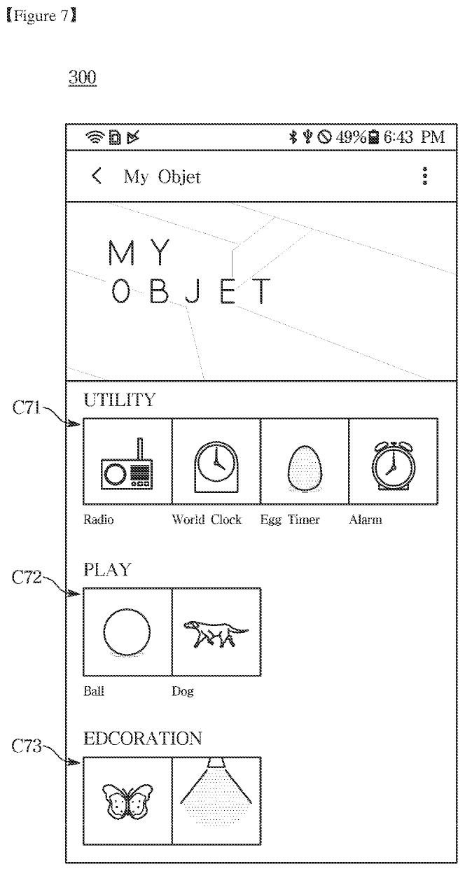

FIG. 7 is a view for describing an operation of a user selecting a category according to an embodiment.

Referring to FIG. 7, the user may determine the categories C71, C72, and C73 of the image data before and after the image data is uploaded. For example, the category of image data may include a radio, clock, timer, and alarm including a specific function, and may be provided as an icon having a simple decorative function. The user may select a plurality of categories C71, C72, and C73 of the image data. For example, when the image data is the dynamic image data, the user may select ‘Ball’ for moving image data. Since the image data can also be used to decorate the display apparatus, the user may select the plurality of categories into categories of “PLAY” and “DECORATION”. The server 200 may provide a content capable of interacting with corresponding image data to the user based on selection C71, C72, and C73 in the user's category.

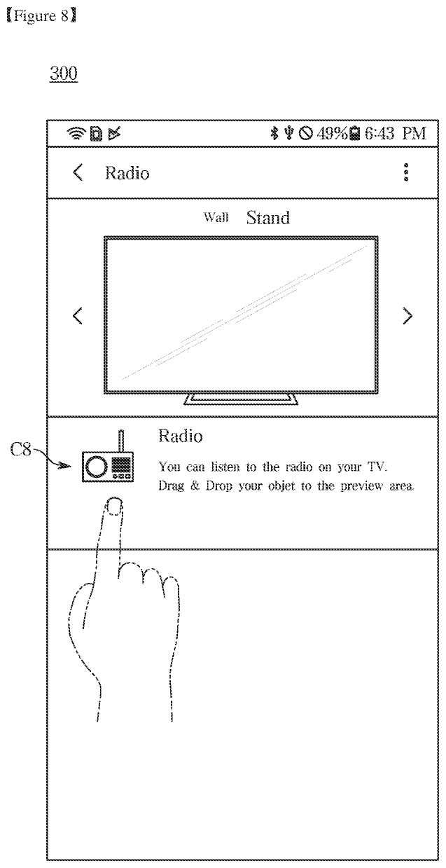

FIG. 8 is a view for describing an operation of forming a content according to an embodiment.

Referring to FIG. 8, when the user uploads the image content of the radio, the server 200 may provide the content C8 corresponding to the radio. The content illustrated in FIG. 8 may be provided as an icon that can be displayed on the display 150 of the display apparatus 100, or may be provided as a content including a manipulation function.

The server 200 may provide pre-stored content based on the category selected by the user in FIG. 7.

The user may utilize the content formed through resources provided in advance from the server 200 without developing separate content.

In the case of the radio illustrated in FIG. 8, the user may determine whether to use the content C8 using drag and drop, or the like, and may adjust the output position. Although only content is illustrated in FIG. 8, there may be a plurality of contents corresponding to one image data, and one or more of the number of contents selected by the user may be provided.

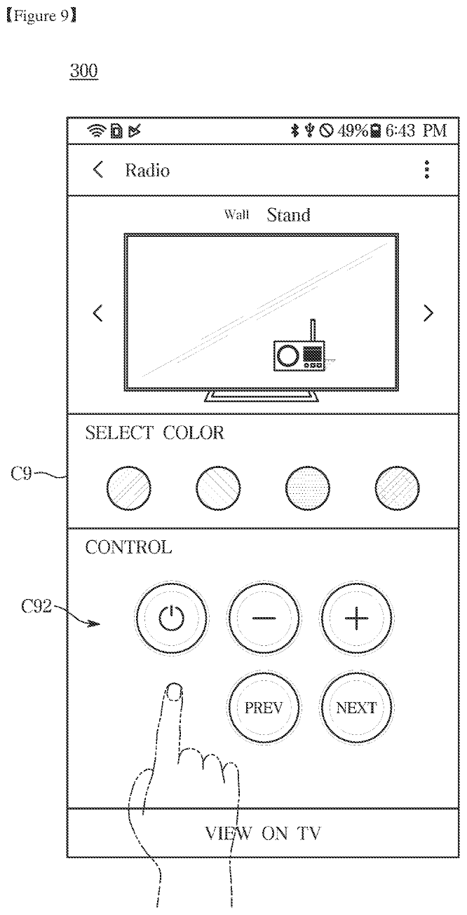

FIG. 9 is a view for describing an operation of providing setting information and operation element according to an embodiment.

The setting information may include the element capable of interaction between the user and the uploaded image data.

The user may change the format of the content output from the display apparatus 100 based on the setting information. For example, the setting information may include information capable of changing the color, shape, and movement of the image output from the display apparatus 100.

Referring to FIG. 9, setting information C91 may be provided as an element capable of setting the color or shape displayed on the display apparatus 100. In FIG. 9, the server 200 may provide the color output to the display apparatus 100 as the setting information C91. The user may determine whether to provide the setting information to change the color of the content to the user. When the user determines to provide the corresponding setting information to the user, the user may change and use the setting information C91 of the corresponding content. According to an embodiment, the user may change a color of a radio icon and use the radio icon to be displayed on the display 150.

The operation element C92 may be provided as elements in which content operates differently through an interaction with the image data. In FIG. 8, since the category is selected as the radio, the server 200 may provide operation element for turning on or off the radio and an interface for adjusting the volume of the radio or moving to a previous or subsequent channel as operation element. When the user determines to provide the previously provided operation element C92 to the user, the user may download the content and perform the operation such as reducing the volume of the corresponding content through the mobile device 300.

FIG. 9 is an embodiment for describing the setting information and the operation element of the content, and as described later, the setting information and the operation element provided by the server 200 may be changed according to the category selected by the user.

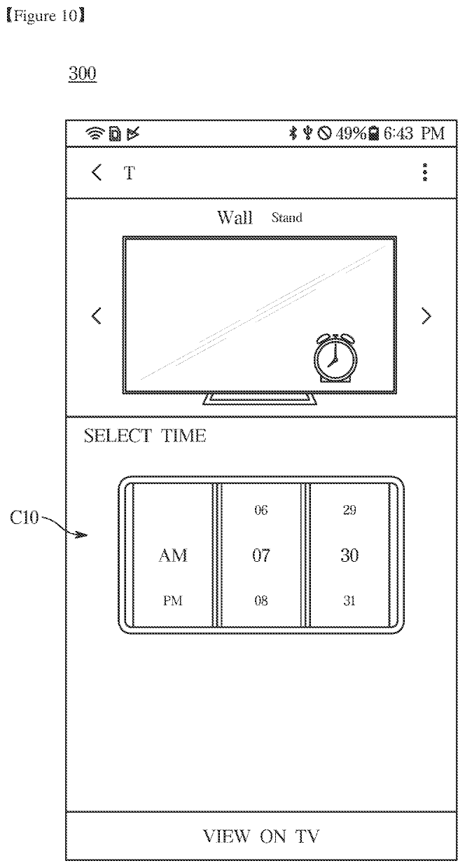

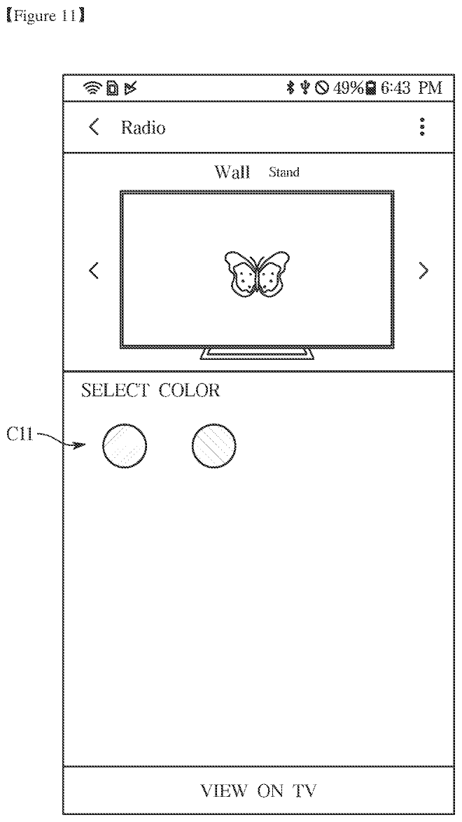

FIGS. 10 and 11 are views for describing an example of operation element and setting information different from those of FIG. 9.

Referring to FIG. 10, FIG. 10 illustrates a case in which the user selects the category related to the alarm, and the alarm needs to provide a visual or audible signal to the user at a specific time.

The server 200 may provide operation element C10 to select the time. The user may set the time required for the alarm based on this. The alarm set in the content may interact with the image data to provide the alarm at a time determined by the user.

Referring to FIG. 11, FIG. 11 is a case in which the user sets a category related to decoration of the display.

The server 200 may provide setting information C11 capable of changing the color of a ‘butterfly’ shape used for decorating on the display. The user may download the above-described content and use the content by changing the color. According to the embodiment, the color of the corresponding content may be provided in blue and orange.

As reviewed in FIGS. 9 to 11 described above, the server 200 may provide content based on selection in the user's category and at the same time provide the setting information and the operation element corresponding to the content.

On the other hand, although limited embodiments have been described in FIGS. 9 to 11, the above description is only an example for describing the operation of the disclosure, and there is no restriction on the type of content or the type of category.

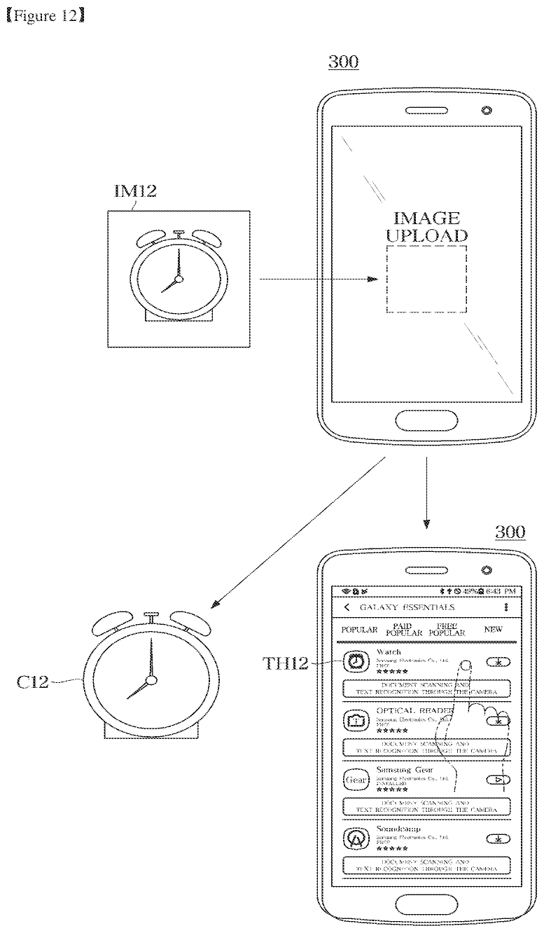

FIG. 12 is a view for describing an operation in which content C12 is uploaded to an app market according to an embodiment.

The server 200 may form a thumbnail TH12 based on image data IM12 uploaded by the user. The thumbnail TH12 and the content C12 provided by the server 200 may be uploaded to at least one app market. The user may input a download command for the content C12 to at least one of the mobile device 200 and the display apparatus 100.

Meanwhile, the user may download the image data and sub-content provided based on the above-described operation, and the user who downloads the content may apply the corresponding content to the display apparatus 100 through the above-described operation.

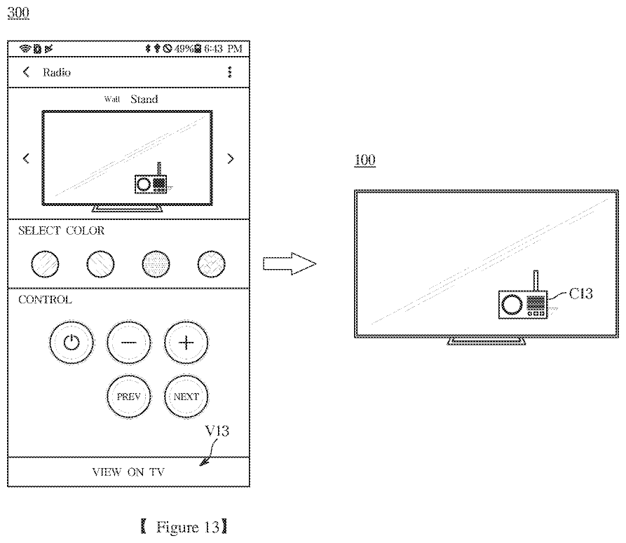

FIG. 13 is a view for describing a preview operation according to an embodiment.

Referring to FIG. 13, as described with reference to FIG. 13, the user may download content C13 uploaded to at least one app market to the display apparatus 100. In addition, the user may control the corresponding content based on the setting information and operation element assigned to the content C13. Meanwhile, the user may input a command to download the content C13 to the display apparatus 100. Before setting the content to be output to the display apparatus 100, the user may recognize the output format of the corresponding content C13 to the mobile device 200 and the display apparatus 100 through a preview command V13.

Meanwhile, the user may change the setting information of the output format of the corresponding content after the preview command In addition, the preview command V13 input by the user may output the type of content output in a predetermined mode and may indicate the output format on a predetermined template. The predetermined template may be provided in the form of a wall paper or the like on which the corresponding content may be output on the display 150.

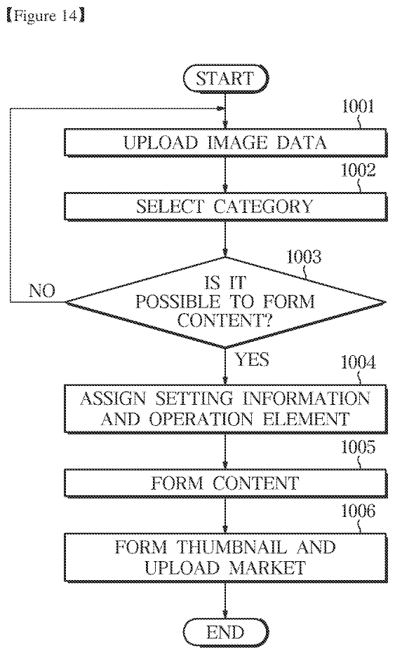

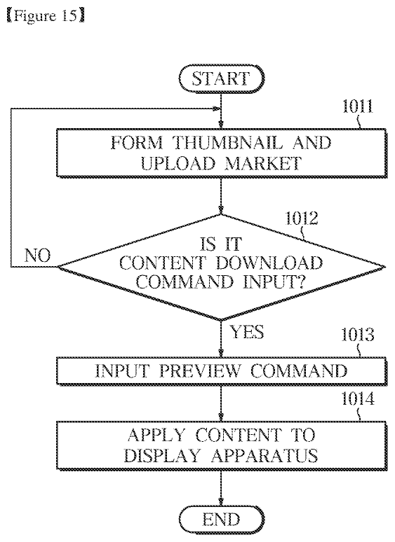

FIGS. 14 to 15 are flowcharts according to an embodiment.

Referring to FIG. 14, the user may upload the image data (1001) and select the category to which the image data corresponds (1002). The category may be provided on the server 200 as described above.

The server 200 may determine whether the content can be formed based on the image data uploaded by the user and the selected category (1003). The server 200 may determine whether the upload form of the image data is correct so that the previously stored resource can form content based on the corresponding image data. When the upload format of the image is not correct, the user may upload again by adjusting the position of the image data. Meanwhile, the server 200 may determine whether to assign the setting information and the operation element applicable to the corresponding content to the corresponding content based on the image data and the category selected by the user (1004). The server 200 may form content that can be output from the display apparatus 100 based on the above-described operation (1005). The server 200 may form the thumbnail based on the image data, and may upload the thumbnail and corresponding content to at least one market.

Referring to FIG. 15, the user may input a content download command for the thumbnail and content 1011 uploaded in FIG. 14 (1012) to download the corresponding content to the display apparatus. Meanwhile, when the user inputs the preview command, the corresponding content may be output to the display apparatus 100 in a preview form (1013). Based on the above-described operation, the corresponding content may be applied to the display apparatus 100 (1014).

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a computer-readable recording medium.

The non-transitory computer-readable recording medium may include all kinds of recording media storing commands that can be interpreted by a computer. For example, the non-transitory computer-readable recording medium may be, for example, ROM, RAM, a magnetic tape, a magnetic disc, flash memory, an optical data storage device, etc.

Embodiments of the disclosure have thus far been described with reference to the accompanying drawings. It should be obvious to a person of ordinary skill in the art that the disclosure may be practiced in other forms than the embodiments as described above without changing the technical idea or essential features of the disclosure. The above embodiments are only by way of example, and should not be interpreted in a limited sense.

1. A display apparatus comprising:
a display;
a communication interface configured to communicate with the server; and
a controller configured to receive a content generated in the server based on image data uploaded by a user to the server, categories selected by the user, and setting information, and to control the content to be output on the display with the setting defined in the setting information.

2. The display apparatus according to claim 1, wherein the content is formed to interact with the image data using a pre-stored resource corresponding to at least one category.

3. The display apparatus according to claim 1, wherein the preset mode is configured to output a screen including the at least one content to the display while the display apparatus is supplied with a low power.

4. The display apparatus according to claim 1, wherein the image data comprises at least one of dynamic and static image data.

5. The display apparatus according to claim 1, wherein the server is configured to determine whether to provide at least one setting information for changing the content based on at least one category selected by the user.

6. The display apparatus according to claim 1, wherein the server is configured to determine whether to provide at least one operation element that manipulates an operation of the content based on at least one category selected by the user.

7. The display apparatus according to claim 1, wherein the server is configured to form a thumbnail for distribution of the content based on the image data, and to upload the content including the thumbnail to at least one app market.

8. The display apparatus according to claim 7, wherein the controller is configured to download the content based on a user's command and output the content to the display.

9. The display apparatus according to claim 1, wherein the setting information comprises at least one of an element in which an interaction between the user and the uploaded image data is possible or an element that changes a form in which the content is displayed on the display.

10. A server comprising:
at least one processor; and
at least one memory configured to be communicatively connected to the at least one processor, and to store a category and a resource corresponding to the content,
wherein the at least one processor is configured to:
communicate with the display;
generate the content based on image data uploaded by a user, at least one category selected by the user, and setting information; and
transmit the content to the display.

11. The server according to claim 10, wherein the content is formed to interact with the image data using a pre-stored resource corresponding to at least one category.

12. The server according to claim 10, wherein the content is formed to output the content with the setting defined in the setting information in a preset mode of the display.

13. The server according to claim 10, wherein the image data comprises at least one of dynamic and static image data.

14. The server according to claim 10, wherein the at least one processor is configured to determine whether to provide at least one setting information for changing the content based on at least one category selected by the user.

15. The server according to claim 10, wherein the at least one processor is configured to determine whether to provide at least one operation element that manipulates an operation of the content based on at least one category selected by the user.
